(19) United States
(12) Patent Application Publication
(10) Pub. No.: US 2010/0050002 A1
(43) Pub. Date: Feb. 25, 2010

(54) Energy-Saving System for Electronic Apparatus

(75) Inventor: Chien-Pang Huang, Taichung City (TW)

Correspondence Address: Wang Law Firm, Inc., 4989 Peachtree Parkway,, Suite 200, Norcross, GA, 30092, US

(73) Assignee: MATRIXVIXION TECHNOLOGY INC., JHONGHE CITY (TW)

(21) Appl. No.: 12/499,078

(22) Filed: Jul. 7, 2009

(30) Foreign Application Priority Data
Aug. 22, 2008 (TW) 097215200

(51) Int. Cl. G06F 1/32; G06F 1/00

(52) U.S. Cl. 713/310; 713/320

(57) ABSTRACT

The present invention discloses an energy-saving system for electronic apparatus, comprising an electronic device and a remote controller. The electronic device includes a power supply module, a microprocessor module and a power-saving module. The microprocessor module is electrically connected to the power supply module. The power-saving module is electrically connected to a power source, the microprocessor module and the power supply module. The remote controller transfers a remote control signal to the power-saving module. Herein, upon receipt of the remote control signal, the power-saving module electrically disconnects the power supply module so as to stop electrical energy supply to the power supply module. Herein the power-saving module consumes 0.08 to 0.12 Watts of electrical energy. Therefore, the energy-saving system for electronic apparatus according to the present invention consumes simply about 0.1 Watts of electrical energy in standby mode, thereby achieving the effect of power-saving.

### BACKGROUND OF THE INVENTION

1. Field of the Invention

The present invention relates to an energy-saving system for electronic apparatus: in particular, the present invention relates to an energy-saving system for electronic apparatus which allows an electronic device to consume only about 0.1 Watts (W) of electrical energy in standby mode.

2. Description of Related Art

Refer first to FIG. 1, wherein a block diagram for a prior art electronic apparatus is shown. The electronic apparatus comprises an electronic device 1 and a remote controller 14. The electronic device includes a power supply module 11, a microprocessor module 12 and a button module 13.

The power supply module 11 is electrically connected to a power source 15. The microprocessor module 12 is electrically connected to the power supply module 11, and initiates the electronic system through the electrical energy supplied by the power supply module 11 to the microprocessor module 12. The button module 13 is electrically connected to the microprocessor module 12, and turns on or turns off the microprocessor module 12 by means of operating on the button module 13 for signal transfer. The remote controller 14 transfers a remote control signal 141 to the microprocessor module 12 to turn on or turn off the microprocessor module 12. When the microprocessor module 12 is turned off, it is in fact not entirely shut down without any power consumption; but rather, it enters into a standby mode.

However, when the microprocessor module 12 is in a standby mode, since it is still required to continuously detect whether the button module 13 or the switch control unit 14 transfers any signals to the electronic device 1, the microprocessor module 12 inevitably needs to consume some electrical energy for facilitating quick startup at any moment, thus the power supply module 11 still incessantly provides the microprocessor module 12 with electrical energy. Due to lack of energy-saving considerations regarding to standby mode in the circuit design of prior art television system, the power supply module 11 needs to consume approximately 1˜10 W of electrical energy when the microprocessor module 12 is in standby mode. For worse circuit designs, such energy consumption may reach even up to 20 W of electrical energy. As a result, prior art electronic systems, although even rarely utilized, still undesirably consume a large amount of electrical energy in standby mode, making users have to pay a big but unnecessary sum of electricity fees, no matter frequently or infrequently operating the electronic apparatus.

### SUMMARY OF THE INVENTION

Regarding to the aforementioned defects found in prior art, the objective of the present invention is to provide an energy-saving system for electronic apparatus, so as to solve the problem for high energy consumption of prior art electronic apparatus in standby mode.

According to the objective of the present invention, herein is proposed an energy-saving system for electronic apparatus, comprising an electronic device and a remote control. A microprocessor module is electrically connected to a power supply module. A power-saving module is electrically connected to a power source, the microprocessor module and the power supply module. The remote controller transfers a remote control signal to the power-saving module. Herein, upon receipt of the remote control signal, the power-saving module electrically disconnects the power supply module so as to stop electrical energy supply to the power supply module.

Herein the power-saving module consumes 0.08 to 0.12 Watts of electrical energy.

As the descriptions set forth hereinbefore, the energy-saving system for electronic apparatus according to the present invention allows disconnection of power energy supplied by the power supply, thus accordingly enabling zero power consumption therein, except that the power-saving module may still need to consume simply about 0.1 Watts of electrical energy in standby mode for uses of power-on signal reception and so on, thereby achieving the effect of power-saving.

### BRIEF DESCRIPTION OF THE DRAWINGS

FIG. 1 shows a block diagram for a prior art electronic apparatus;

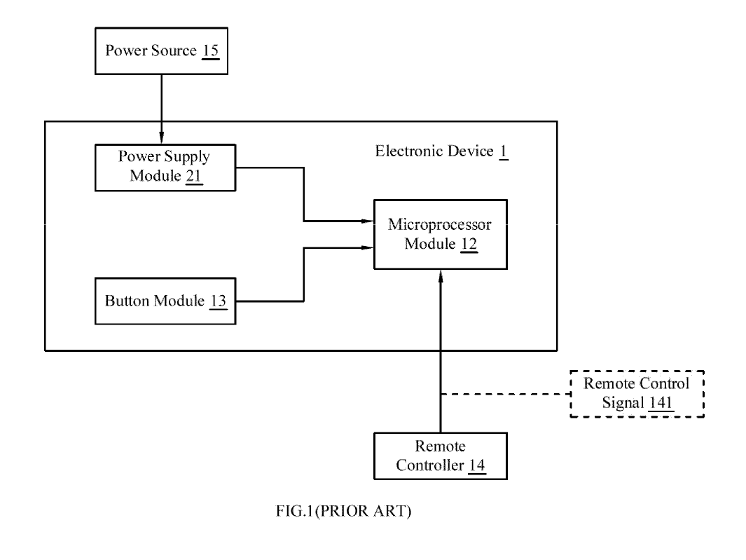

FIG. 2 shows a block diagram of the energy-saving system for electronic apparatus according to the present invention; and

FIG. 3 shows a block diagram of an embodiment of the energy-saving system for electronic apparatus according to the present invention.

### DETAILED DESCRIPTION OF THE PREFERRED EMBODIMENTS

Several embodiments of the energy-saving system for electronic apparatus according to the present invention will now be described in details with reference to the appended drawings.

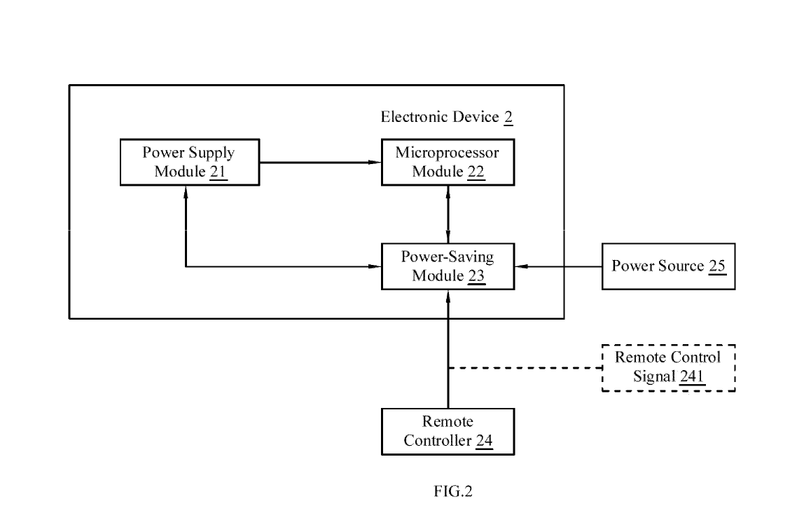

Refer first to FIG. 2, wherein a block diagram of the energy-saving system for electronic apparatus according to the present invention is shown. In the Figure, the energy-saving system for electronic apparatus is depicted as comprising an electronic device 2 and a remote controller 24. The electronic device 2 includes a power supply module 21, a microprocessor module 22 and a power-saving module 23. Herein the electronic device 2 is implemented as a television in the present embodiment, but it is by no means limited thereto. For example, the electronic device 2 may be an electronic apparatus such as an air conditioner, a heater, a stereo or an audio/video player etc.

The microprocessor module 22 is electrically connected to the power supply module 21. The power-saving module 23 is electrically connected to a power source 25, the microprocessor module 22 and the power supply module 21. The remote controller 24 transfers a remote control signal 241 to the power-saving module 23. When a user is not watching TV programs, the remote controller 24 transfers a remote control signal 241 to the power-saving module 23. Upon receipt of the remote control signal 241, the power-saving module 23 electrically disconnects the power supply module 21, making the power source 25 stop supplying power to the power supply module 21 and thereby enabling complete power off in the power supply module 21 without consuming any electrical energy. Under such a condition, only the power-saving module 23 continues to operate in the electronic device 2, and the power-saving module 23 consumes simply about 0.08 Watts (W) to 0.12 W of electrical energy, thus achieving the objective of energy-saving.

In case the user intends to watch TV programs, a remote control signal 241 can be transferred to the power-saving module 23 by the remote controller 24, and upon receipt of the remote control signal 241, the power-saving module 23 then can electrically re-connect the power supply module 21, such that the power supply module 21 restores to a normal power supply status.

The aforementioned power-saving module 23 comprises electronic components such as control circuits, rectifiers, capacitors and power relay units etc., and the rectifiers are used for conversions of alternative current (AC) into direct current (DC).

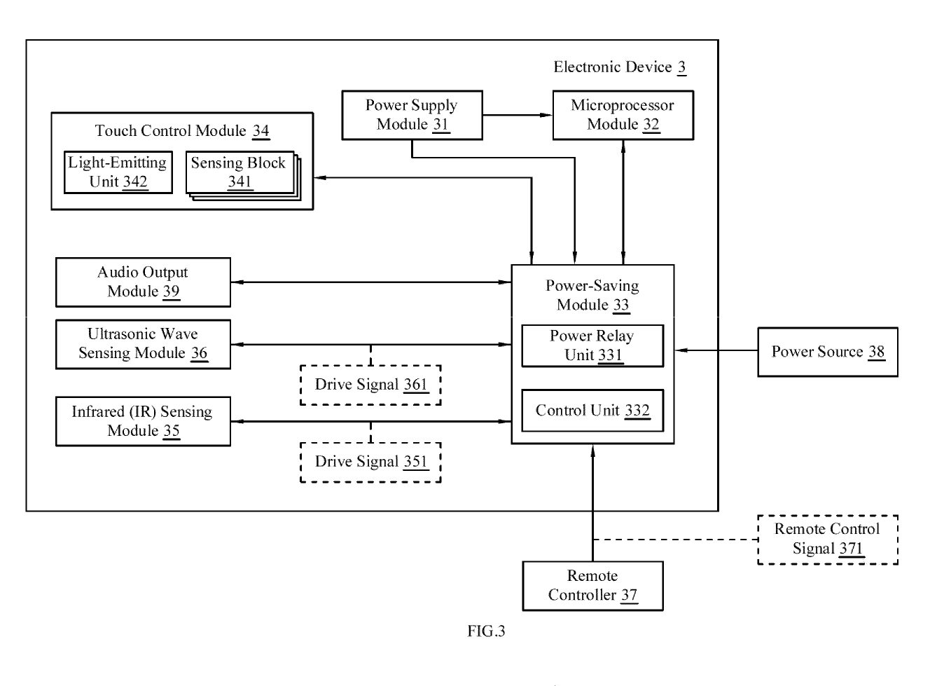

Refer next to FIG. 3, wherein a block diagram of an embodiment of the energy-saving system for electronic apparatus according to the present invention is shown. In the Figure, the depicted energy-saving system for electronic apparatus comprises an electronic device 3 and a remote controller 37. The electronic device 3 includes a power supply module 31, a microprocessor module 32, a power-saving module 33, a touch control module 34, an infrared (IR) sensing module 35 and an ultrasonic wave sensing module 36. The remote controller 37 transfers a remote control signal 371 to the power-saving module 33. The touch control module 34 includes a light-emitting unit 342 and a plurality of sensing blocks 341. In the present embodiment, the electronic device is implemented as a television, but it is by no means limited thereto. For example, the electronic device 2 may be an electronic apparatus such as an air conditioner, a heater, a stereo or an audio/video player etc.

The microprocessor module 32 is electrically connected to the power supply module 31. The power-saving module 33 is electrically connected to a power source 38, the microprocessor module 32 and the power supply module 31. The touch control module 34 is electrically connected to the power-saving module 33. The power-saving module 33 comprises a power reply unit 331 and a control unit 332, in which the power reply unit 331 is used to electrically connect or electrically disconnect the power supply module 31, and the control unit 332 receives the remote control signal 371.

When a user is not watching TV programs, the remote controller 37 is made to transfer a remote control signal 371 to the power-saving module 33. When the power-saving module 33 receives the remote control signal 371, it disconnects the power supply module 31 through the power relay unit 331 to stop supplying power from the power source 38 to the power supply module 31, allowing the power supply module 31 to entirely power off. At this time, only the power-saving module 33 continues to operate in the electronic device 3, and the power-saving module 33 consumes just approximately 0.1 W of electrical energy, thereby achieving the objective of power-saving.

The user may also turn on or off the electronic device 3 through the touch control module 34. When the user is not watching TV programs, the user touches a corresponding sensing block 341 on the touch control module 34, causing the touch control module 34 to transfer a drive signal to the power-saving module 33, further disconnecting power supplied by the power supply module 31, thereby achieving the objective of power-saving. When the user intends to watch TV programs, he/she may touch the corresponding sensing block 341 on the touch control module 34, making the touch control module 34 transfer a drive signal to the power-saving module 33, further allowing the power relay unit 331 to electrically connect to the power supply module 31 for restoring the electronic device 3 back to standby mode; and when the user switches channels or adjusts volume output, the user touches the corresponding sensing block 341 on the touch control module 34, causing it to output a command code to the control unit 332, transferring the command code to the microprocessor module 32 by means of the control unit 332, thus achieving the objective of channel switching or volume adjustment.

The IR sensing module 35 is electrically connected to the power-saving module 33 and the touch control module 34. When the user approaches to the electronic device 3 (approximately 0˜3 meters), the IR sensing module 35 transfers a signal to the touch control module 34, allowing the light-emitting unit 342 to illuminate, thereby lively prompting the location of the sensing block 341 to the user. As the user gets closer to the electronic device 3, the IR sensing module 35 transfers a drive signal 351 to the power-saving module 33, making the power supply module 31 restore to normal power supply mode; conversely, as the user moves away from the electronic device 3, the IR sensing module 35 transfers a drive signal 351 to the power-saving module 33, thereby disconnecting power supplied by the power supply module 31 to achieve the objective of power-saving.

The ultrasonic wave sensing module 36 is electrically connected to the power-saving module 33 and the touch control module 34. When the user approaches to the electronic device 3 (approximately 0˜50 centimeters), the ultrasonic wave sensing module 36 transfers a drive signal 361 to the touch control module 34, causing the light-emitting unit 342 to illuminate, thereby lively prompting the location of the sensing block 341 to the user. Contrarily, when the user steps away from the electronic device 3, the ultrasonic wave sensing module 36 transfers a drive signal 361 to the power-saving module 33 to disconnect power supplied by the power supply module 31, so as to achieve the objective of power-saving.

The electronic device 3 may be also optionally installed with an audio output module 39, which is electrically connected to the power-saving module 33, and when the power-saving module 33 disconnects or restores power supply from the power supply module 31, the audio output module 39 can output a prompt message to remind the user that the electronic device 3 has now entered into a power-saving mode or returned to a standby mode.

Herein the aforementioned IR sensing module 35 comprises an IR receiver, a signal reception amplification circuit and a waveform comparing circuit; the ultrasonic wave sensing module 36 comprises an ultrasonic wave emission receiver, an ultrasonic wave emission drive circuit, a reception amplification circuit and a waveform comparing circuit; and the audio output module 39 may comprise an audio component, such as a speaker.

In summary, the energy-saving system for electronic apparatus according to the present invention can achieve the objective of power-saving through disconnecting or restoring power supply from the power supply module by means of the power-saving module.

The descriptions illustrated as above are exemplary, rather than being limiting. All effectively equivalent modifications or changes made to the embodiments of the present invention without departing from the spirit and scope thereof are deemed as being included in the claims set forth hereunder.

What is claimed is:

1. An energy-saving system for electronic apparatus, comprising:
an electronic device, including
a power supply module;
a microprocessor module, electrically connected to the power supply module;
a power-saving module, electrically connected to a power source, the microprocessor module and the power supply module; and
a remote controller, transferring a remote control signal to the power-saving module;
wherein, upon receipt of the remote control signal, the power-saving module electrically disconnects the power supply module so as to stop electrical energy supply to the power supply module.

2. The energy-saving system for electronic apparatus according to claim 1, wherein the power-saving module consumes 0.08 to 0.12 Watts of electrical energy.

3. The energy-saving system for electronic apparatus according to claim 1, wherein the power-saving module consists of a power relay unit and a control unit, in which the power relay unit is used to electrically connect or electrically disconnect the power supply, and the control unit receives the remote control signal.

4. The energy-saving system for electronic apparatus according to claim 1, wherein the electronic device further comprises a touch control module, in which the touch control module is electrically connected to the power-saving module so as to drive the power-saving module to electrically connect or electrically disconnect the power supply.

5. The energy-saving system for electronic apparatus according to claim 4, wherein the touch control module further comprises a light-emitting unit and a plurality of sensing blocks, in which the light-emitting unit notifies the locations of such sensing blocks to the user.

6. The energy-saving system for electronic apparatus according to claim 4, wherein the electronic device further comprises an infrared sensing module, in which infrared sensing module is electrically connected to the power-saving module and the touch control module, and detects the position of the user from the electronic device so as to accordingly transfer a drive signal to the power-saving module.

7. The energy-saving system for electronic apparatus according to claim 4, wherein the electronic device further comprises an ultrasonic wave sensing module, in which the ultrasonic wave sensing module is electrically connected to the touch control module, and detects the position of the user from the electronic device so as to accordingly transfer a drive signal to the power-saving module.
